(19) United States
(12) Patent Application Publication
(10) Pub. No.: US 2025/0089624 A1
(43) Pub. Date: Mar. 20, 2025

(54) DUAL COMPARTMENT CONTAINER

(71) Applicant: Richard P. Steinke, II, Indio, CA (US)

(72) Inventor: Richard P. Steinke, II, Indio, CA (US)

(21) Appl. No.: 18/892,047

(22) Filed: Sep. 20, 2024

Related U.S. Application Data
(60) Provisional application No. 63/583,907, filed on Sep. 20, 2023.

(51) Int. Cl. A01F 25/14

(52) U.S. Cl. CPC A01F 25/14

(57) ABSTRACT

A dual compartment container is disclosed. The dual compartment container includes a container body having a proximal end and a distal end opposite the proximal end. Disposed between the proximal end and the distal end is a separator coupled to the container body. The separator forms a first compartment a second compartment wherein the first compartment is isolated from the second compartment and the second compartment is isolated from the first compartment. The dual compartment configuration has a myriad of benefits including freshness preservation and improved storage and transportation.

### CROSS-REFERENCE TO RELATED APPLICATIONS

This application claims benefit of priority with U.S. Provisional Application Ser. No. 63/583,907, filed Sep. 20, 2023; the entire contents of which are hereby incorporated by reference.

### BACKGROUND

### Field of the Invention

This invention relates to containers; more particularly, to dual compartment containers.

### Description of the Related Art

Conventional containers for goods, such as food and drink, are stored, transported and sold individually. Complementary goods must be purchased separately. Additionally, some containers of goods lose freshness and quality after being initially opened, thereby forcing the purchaser to consume the entire contents of the packaging or disposing of the leftovers.

There is a need for a container that simplifies the purchase, transportation, and storage of complimentary goods, as well as preserving freshness of contents contained therein.

### SUMMARY

A dual compartment container is disclosed. The dual compartment container comprises a container body having a proximal end and a distal end opposite the proximal end. Disposed between the proximal end and the distal end is a separator coupled to the container body. The separator forms a first compartment a second compartment wherein the first compartment is isolated from the second compartment and the second compartment is isolated from the first compartment. The dual compartment configuration has a myriad of benefits including freshness preservation and improved storage and transportation.

### BRIEF DESCRIPTION OF THE DRAWINGS

Other features, combinations, and embodiments will be appreciated by one having the ordinary level of skill in the art upon a thorough review of the following details and descriptions, particularly when reviewed in conjunction with the drawings, wherein:

FIG. 1 shows a cross-section view of a dual compartment container in accordance with a first illustrated embodiment;

FIG. 2A shows a cover of the dual compartment container according to an embodiment;

FIG. 2B shows an alternate cover of the dual compartment container according to an embodiment;

FIG. 3 shows a cross-section view of the dual compartment container according to a second illustrated embodiment;

FIG. 4 shows a cross-section view of the dual compartment container according to a third illustrated embodiment;

FIG. 5 shows a perspective view of the dual compartment container with a mixing mechanism in accordance with a fourth illustrated embodiment;

FIG. 6A shows a top view of the dual compartment container with the mixing mechanism according to the fourth illustrated embodiment;

FIG. 6B shows a top and bottom view of the dual compartment container with the mixing mechanism according to the fourth illustrated embodiment;

FIG. 7 shows a front view of a separator of the dual compartment container with the mixing mechanism according to the fourth illustrated embodiment;

FIG. 8 shows a perspective view of the dual compartment container in accordance with a fifth illustrated embodiment;

FIG. 9 shows a side view of a lid of the dual compartment container according to the fifth illustrated embodiment;

FIG. 10 shows a perspective view of the dual compartment container in accordance with a sixth illustrated embodiment;

FIG. 11 shows a diagram for manufacturing a metallic dual compartment container;

FIG. 12 shows a flowchart for manufacturing a metallic dual compartment container;

FIG. 13 shows a process for manufacturing a metallic dual compartment container;

FIG. 14A shows a diagram for blow molding manufacturing;

FIG. 14B shows a diagram for blow molding manufacturing; and

FIG. 14C shows a diagram for blow molding manufacturing.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “independently accessible” means two compartments having distinct openings for access such that opening one compartment does not require the opening of the other compartment.

The term “equivalent substances” means having the same composition and chemical structure.

The term “dual compartment container” means a container with two or more compartments. A dual compartment container may further a plurality of sub-compartments in one or both compartments.

Unless explicitly defined herein, terms are to be construed in accordance with the plain and ordinary meaning as would be appreciated by one having skill in the art.

### GENERAL DESCRIPTION OF EMBODIMENTS

In one general embodiment, a dual compartment container is disclosed. The dual compartment container comprises a container body extending from a proximal end to a distal end opposite the proximal end, the container body further comprising a hollow interior surrounded by inner walls. A separator is disposed within the hollow interior, the separator coupled to the inner walls by a sealing mechanism. A first compartment extends from the separator to the proximal end, the first compartment having a first volume and configured to store a first substance. A second compartment extends from the separator the distal end, the second compartment having a second volume and configured to store a second substance. A proximal opening is disposed at the proximal end for accessing contents within the first compartment. A distal opening is disposed at the distal end for accessing contents within the second compartment. Wherein the first compartment and second compartment are independently accessible.

In some embodiments, the separator may extend radially from the hollow interior to the inner walls of the container body.

In some embodiments, the sealing mechanism may comprise welding, brazing, press-fit with gasket, crimping, ultrasonic welding, snap fit with O-ring, adhesive bonding, thermal sealing, compression fit with gasket, mechanical fastening with epoxy, glass bonding with frit seal, or the like.

In some embodiments, the separator may isolate the first compartment from the second compartment.

In some embodiments, the separator may further comprise a planar formation and a separator periphery defining a perimeter of the planar formation, wherein the separator periphery comprises a same periphery as an interior periphery formed by the inner walls.

In some embodiments, the first volume may equal the second volume. In other embodiments, the first volume is greater than the second volume.

In some embodiments, the proximal opening and the distal opening may each comprises a pop top. Each pop top may form a hermetic seal and further comprises an elastomeric sealing ring.

In some embodiments, the proximal opening and the distal opening may each further comprise a removable snap cover configured to detachably couple to the respective opening.

In some embodiments, the first compartment may further comprise the first substance stored therein, and the second compartment further comprising the second substance stored therein, wherein the first substance and the second substance are equivalent.

In some embodiments, the separator may comprise an impermeable membrane configured to prevent mixing of the first substance and the second substance.

In some embodiments, the separator may comprise an airtight seal between the first compartment and the second compartment.

In some embodiments, the container may further comprise a sensor configured to measure at least one of the first compartment and the second compartment. The sensor may be configured to measure at least one of pressure, temperature, and carbon dioxide. The container may comprise a remote monitoring subsystem comprising the sensor, a battery and a wireless connectivity module. The sensor may be integrated within the separator. The sensor may be configured to measure both the first compartment and the second compartment. The sensor may be integrated within a cover of the container.

In some embodiments, the container may further comprise a reinforcement element coupled to the separator for increased strength. The reinforcement element may be further coupled to the inner walls.

In another general embodiment, a dual compartment container is disclosed. The dual compartment container comprises a container body extending from a proximal end to a distal end opposite the proximal end, the proximal end forms a container top side and the distal end forms a container bottom side, the container body further comprises a hollow interior surrounded by inner walls. A separator divides the hollow interior into a first compartment and a second compartment, the separator comprising a first half and a second half. A plurality of perforated seals is coupled to both the separator and the inner walls for creating a barrier between the first compartment and the second compartment, wherein each of the plurality of perforated seals is configured to break upon rotation of the separator. A center post rod is disposed between the first half and the second half of the separator, wherein the center post rod is rotatably coupled to the container bottom side.

In some embodiments, the first compartment and the second compartment may each be accessible from the container top side.

In some embodiments, the plurality of perforated seals may further comprise a first perforated side seal coupled to the first half of the separator and further coupled to a portion of the inner walls, a second perforated side seal coupled to the second half of the separator and further coupled to a portion of the inner walls opposite the first perforated side, and a perforated bottom seal coupled to the separator and further coupled to the container bottom side. The perforated bottom seal may be coupled to both the first half and the second half. In some embodiments, the plurality of perforated seals further comprises a perforated seal coupled to the top edge of the separator.

In some embodiments, the first half of the separator extends away from the center post rod in a direction opposite the second half of the separator.

In some embodiments, the container may further comprise a twist tab coupled to the center post rod. The twist tab may be above the hollow interior.

In some embodiments, the first half and the second half each comprise a contoured surface. The first half and the second half may be characterized as being in a mirror configuration. Each of the contoured surfaces may comprise a curvature wherein the curvature decreases toward the center post rod.

In some embodiments, the separator may be configured to rotate both clockwise and counterclockwise.

In another general embodiment, a dual compartment container is disclosed. The dual compartment container comprises a first container comprising a first container body extending from a first proximal end to a first distal end, the first container body forming a first compartment, a first proximal opening disposed at the first proximal end, the first proximal opening comprising a first opening threads, and a first lid configured to engage with the first opening threads, the first lid further comprising a first lid outer periphery and a first lid inner periphery. The first lid inner periphery comprises a first internal threads configured to engage with the first opening threads, the first lid outer periphery comprising a first external threads. A first threaded recess is disposed at the first distal end of the first container body. The dual compartment container further comprises a second container comprising a second container body extending from a second proximal end to a second distal end, the second container body forming a second compartment, a second proximal opening disposed at the second proximal end, the second proximal opening comprising a second opening threads, and a second lid configured to engage with the second opening threads, the second lid further comprising a second lid outer periphery and a second lid inner periphery. The second lid inner periphery comprises a second internal threads configured to engage with the second opening threads. The second lid outer periphery comprises a second external threads. A second threaded recess is disposed at the second distal end of the second container body. The second external threads are configured to engage with the first threaded recess, and the first external threads are configured to engage with the second threaded recess.

In some embodiments, the dual compartment container may further comprise gripping grooves disposed on the first lid outer periphery. The gripping grooves may comprise a thread direction orthogonal to the first external threads. The gripping grooves may be disposed above the first external threads when the first lid is engaged with the first container such that the first external threads are disposed between the gripping grooves and the first container.

In some embodiments, the first external threads and the first internal threads may be disposed on opposite sides of the first lid such that the external threads are directly opposite the first internal threads.

In some embodiments, the dual compartment container may further comprise a sensor configured to measure at least one of the first compartment and the second compartment. The sensor may be configured to measure at least one of pressure, temperature, and carbon dioxide. The container may comprise a remote monitoring subsystem comprising the sensor, a battery and a wireless connectivity module. The sensor may be configured to measure both the first compartment and the second compartment. The sensor may be integrated within a cover of the container.

### Manufacturing

The container body may comprise any materials as can be appreciated by one having skill in the art, including but not limited to metal, glass, plastic, or a combination thereof. In some embodiments, the container body comprises an aluminum can with the proximal opening and the distal opening having pop tops with pull tabs being optionally hermetically sealed. The container body may comprise rotating lids or screw tops with threaded elements. The covers for the proximal opening and distal opening may be same or different.

The sensor of the remote monitoring subsystem may be configured to measure various parameters including pressure, direct CO₂ levels, temperature, pH balance, low ppm sensing to high ppm sensing, or a combination thereof. The subsystem comprises a power source such as a battery which is sealed from either compartment of the container. The remote monitoring subsystem may comprise wireless capabilities including Bluetooth or NFC. In some embodiments, the remote monitoring subsystem may further comprise GPS capabilities for tracking the container.

The first compartment and the second compartment may comprise a same volume or different volumes. For example, in a 12-ounce can, the first compartment and second compartment may each comprise 6 ounces. Or, the first compartment may comprise 9 ounces and the second compartment may comprise 3 ounces.

Methods of manufacture can be various techniques including blow molding, injection molding, two-piece can manufacture processes, and glassblowing processes.

In one aspect, a method of manufacturing a dual compartment metallic can is disclosed. The aluminum coils arrive at the can plant and are loaded one at a time onto an “uncoiler”—a machine that unrolls the strip of aluminum at the beginning of the can making line and feeds it to the line, where it is first lubricated. Lubrication helps the aluminum flow smoothly during the can shaping processes that follow. Sheets are inspected for surface defects and imperfections, ensuring high-quality starting material. Two aluminum sheets are each sized for a single can compartment. Both sheets are treated to achieve the desired thickness, typically around 0.10-0.15 mm. Both sheets are then preheated to approximately 900-950° C. to soften the aluminum for shaping. The drawing presses are employed to form each sheet into a cup shape. Each cup-shaped sheet is ironed to achieve the final desired thickness. An optional annealing process at 350-400° C. may be employed to relieve stresses and restore mechanical properties. Next, the necking process is performed for each can compartment to create openings for pop-top lids, adhering to strict dimensional tolerances. Lubrication during necking with food-grade lubricants is used to reduce friction while maintaining product safety. A large machine called a cupping press is used for the can shaping process. The press cuts circular discs from the aluminum sheet and forms them into shallow cups. The cups drop from the press onto the cup conveyor. Ensure neck dimensions match precisely with pop-top lid specifications. Typical dimensions: neck diameter of 53-57 mm, height around 7-9 mm, with allowances for variations within microns. From the cupping press, the cups are drawn up into higher cups through a series of iron rings. Align the necked ends of both compartments accurately. A specially designed chuck made from stainless steel is utilized for joining the two cylinders. A sealing mechanism is incorporated into the chuck design, utilizing food-grade O-rings or gaskets made of materials compliant with food safety regulations. A radial pressure is applied evenly around the circumference of the necked ends using a two-part crimping mechanism for ultimate sealing precision. The first part of the crimping mechanism applies precisely controlled initial pressure to secure the chuck and create a preliminary seal. This pre-crimping step ensures uniform contact between the chuck and the can compartments. The second part of the crimping mechanism applies calibrated radial pressure to complete the seal with microstrain accuracy. As pressure is applied, the aluminum material of the necked ends undergoes controlled deformation, forming a hermetic seal at the interface of the two compartments. Next, one compartment is filled with the desired beverage, maintaining precise fill levels through automated volumetric controls. The first pop-top lid is securely attached to the filled compartment's necked end, ensuring a hermetic seal with tamper-evident features. The second compartment is filled with a different or the same beverage, adhering to the same strict fill level standards. The second pop-top lid is securely attached the second compartment's necked end, ensuring a secure seal with integrated tamper-proof technology.

In another aspect, a method of manufacturing a dual compartment plastic bottle is disclosed. Plastic material choice can vary and can include polyethylene terephthalate (PET), high-density polyethylene (HDPE), or polypropylene (PP). In some embodiments, a combination of these plastics may be employed to achieve the desired properties such as strength, clarity, and barrier resistance. The manufacturing process begins with the production of a preform—a small, thick-walled tube of plastic that is heated and then blown into the final container shape. The preform design will vary based on the size of the final container, e.g., 2-liter or 16-ounce bottles. Preforms are produced using injection molding. Plastic pellets are melted and injected into a preform mold to create the solid, tube-like structure. For dual compartment containers, the preform design will need to accommodate two separate chambers. This involves creating a preform with a bifurcated internal structure. The preforms are heated in an oven to a temperature that makes them soft and pliable, typically around 240-260° C. (464-500° F.). Once heated, the preforms are transferred to a blow molding machine. For dual compartment containers, a two-step blowing process is performed wherein a first blowing step expands the first compartment, and a second blowing step expands the second compartment. After the container is fully expanded and formed, it is cooled to solidify the plastic. This step ensures that the container retains its shape and structural integrity.

Each of the components of the dual compartment container described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### Illustrated Embodiments

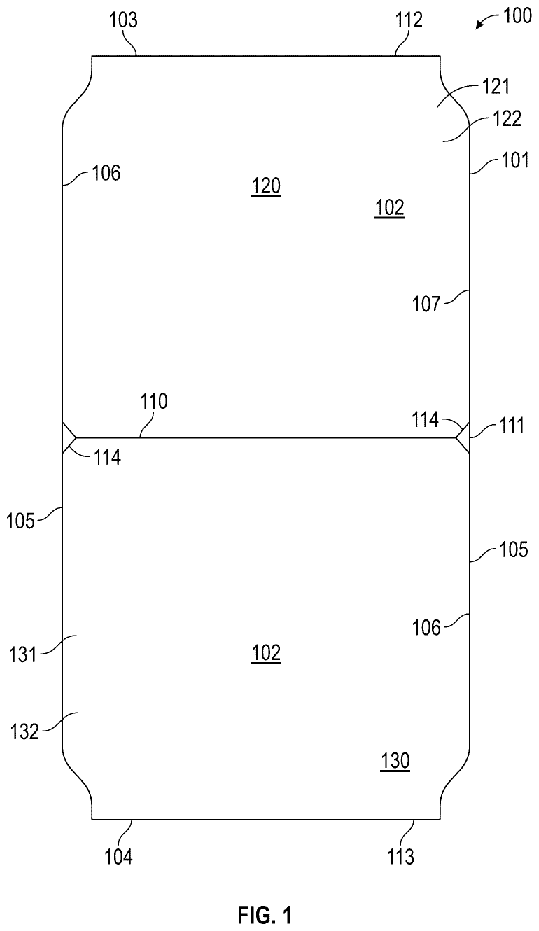

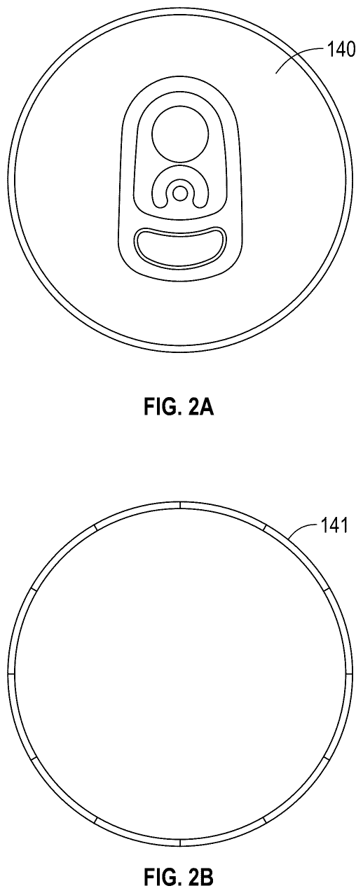

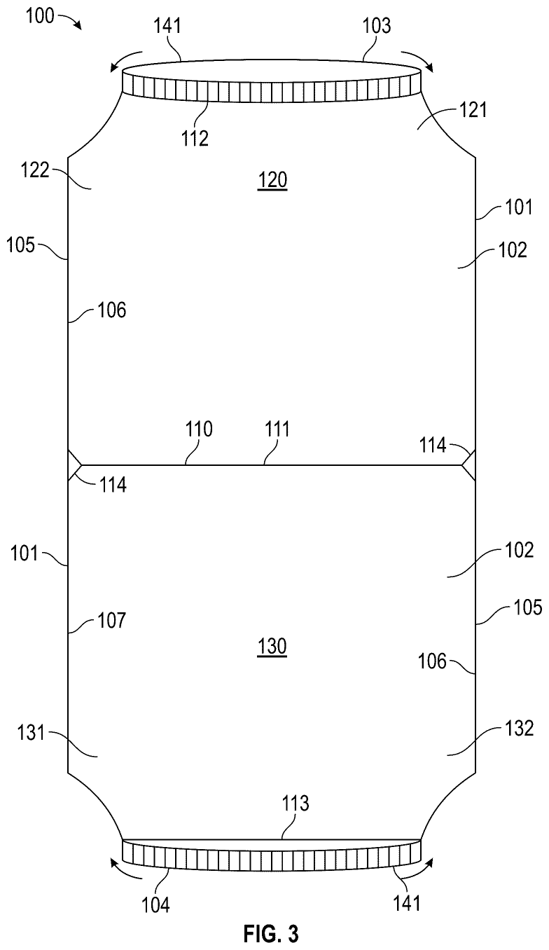

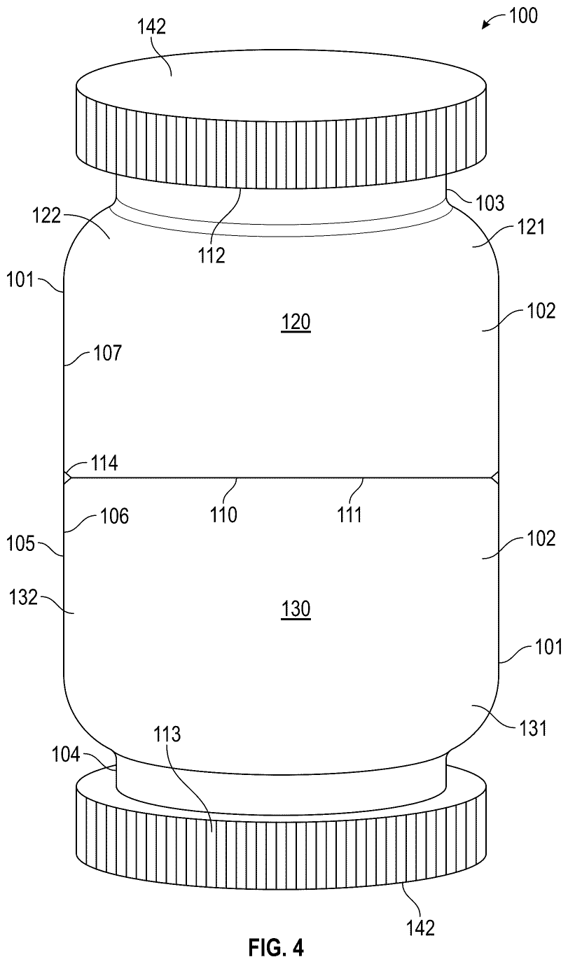

FIG. 1-4 shows a dual compartment container (100) in accordance with various embodiments. The dual compartment container comprises a container body (101) extending from a proximal end (103) to a distal end (104). The container body comprises a hollow interior (102) surrounded by inner walls (106). Opposite the inner walls is an exterior surface (105) which a user is capable of contacting. Disposed within the hollow interior is a separator (110) that divides the hollow interior into two separate and independent compartments, namely a first compartment (120) and a second compartment (130). The first compartment extends from the separator to the proximal end, and the second compartment extends from the separator to the distal end. The proximal end comprises a proximal opening (112) for accessing a first substance (122) within the first compartment. The distal end comprises a distal opening (113) for accessing a second substance (132) within the second compartment.

The separator (110) forms a sealed coupling to the inner walls (106) of the container body (101) by a scaling mechanism. Sealing mechanisms can include welding, brazing, press-fit with gasket, crimping, ultrasonic welding, snap fit with O-ring, adhesive bonding, thermal scaling, compression fit with gasket, mechanical fastening with epoxy, glass bonding with frit seal, or the like. The sealed coupling allows for the separator to be an impermeable membrane to avoid mixing of the substances in the first compartment and the second compartment that can include solids and/or fluids. An airtight seal of the separator segregates the two substances which can be equivalent or complementary to each other. Having equivalent substances in the first and second compartments preserves freshness of one of the substances being opened at a later time. For complementary substances, the dual compartment container allows for a convenient packaging and storage vessel where the complimentary products can be used together.

The first compartment (120) comprises a first volume (121) and the second compartment (130) comprises a second volume (131). In some embodiments, the first volume is equal to the second volume. This can be useful in applications such as pressurization equalization or where the two substances are used in generally equal proportions. In other embodiments, the first volume is greater than the second volume. To maximize both the first and second volumes, the separator may comprise a planar formation, such as a disc, with a generally flat substrate. One having skill in the art will appreciate that reinforcement elements and curvature of the separator for structural integrity is still interpreted as the separator being generally a flat substrate. The container body comprises an interior periphery (107) formed by the inner walls (106). The interior periphery may comprise a circular or round shape as is common in conventional containers such as aluminum cans or metal/plastic bottles. The separator may comprise a separator periphery (111) that comprises the same periphery as the interior periphery in order for the separator to efficiently isolate the first compartment from the second compartment.

Various types of containers may utilize the dual compartment configuration as disclosed herein. Examples may include metallic cans, plastic bottles, glass bottles, or any other container as can be appreciated by one having skill in the art. Substances contained within each compartment may be edible or inedible. The dual compartment container can be used in various industries including food, medical, consumer, industrial, and the like. Generally, the proximal opening (112) and the distal opening (113) each comprise a cover to store contents therein while not in use. Covers may include pop tops (140) with hermetic seal and elastomeric scaling ring, removable snap covers (141) configured to detachably couple and decouple for repeated use, and threaded covers (142) typically seen in plastic and glass bottles.

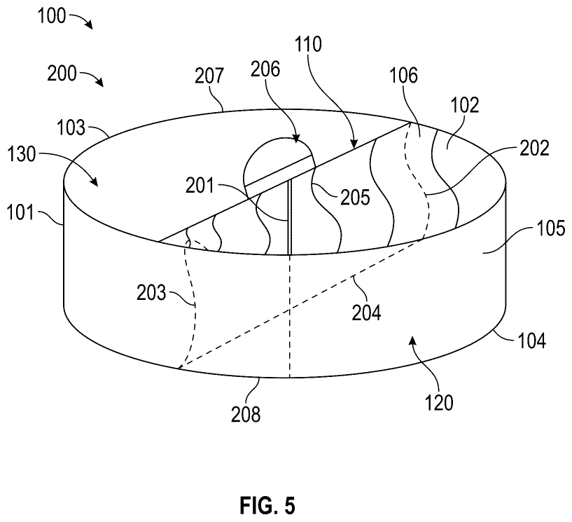

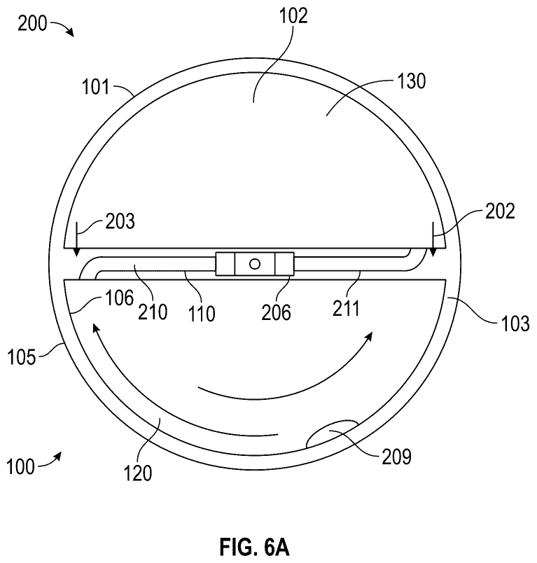

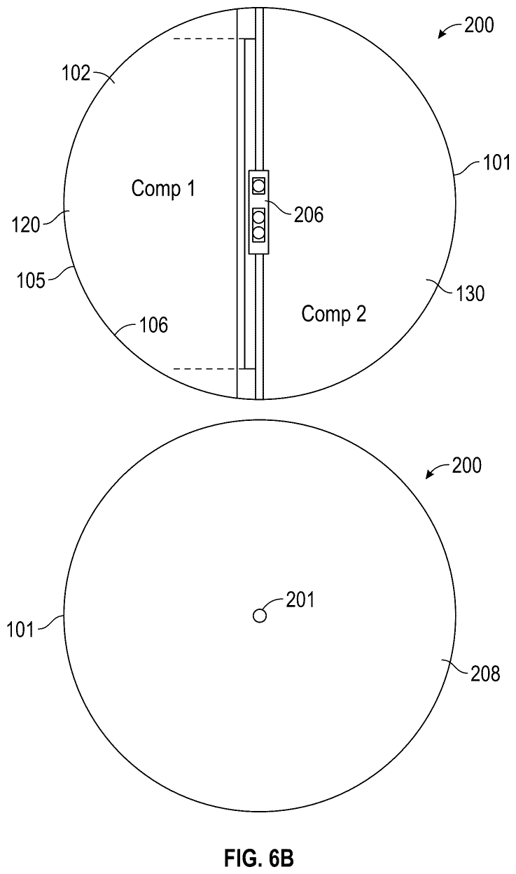

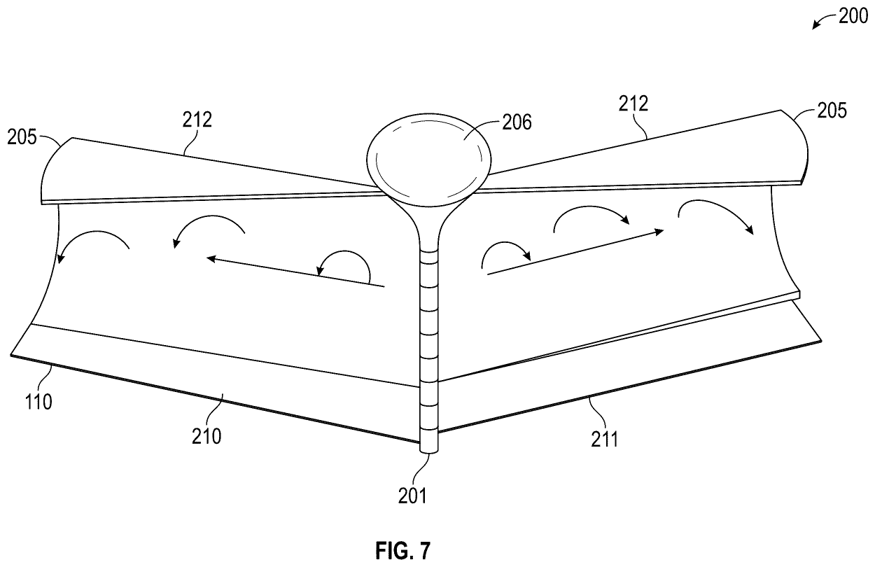

FIG. 5-7 show a dual compartment container (100) with a mixing mechanism (200) according to a fourth illustrated embodiment. The dual compartment container comprises a container body (101) extending from a proximal end (103) to a distal end (104). The proximal end forms a container top side (207) and the distal end forms a container bottom side (208) opposite the container top side. The dual compartment container further comprises an external surface (105) and inner walls (106) opposite the external surface wherein the inner walls surround a hollow interior (102). A separator (110) divides the hollow interior into a first compartment (120) and a second compartment (130) such that contents in the first compartment are isolated from contents in the second compartment. The separator is coupled to the inner walls and the bottom container side by a plurality of perforated seals, namely a first perforated side seal (202), a second perforated side seal (203), and a perforated bottom seal (204). The first perforated side seal couples a first half (210) of the separator to the inner wall at one side of the container body. The second perforated side seal couples a second half (211) of the separator to the inner wall opposite the first perforated side seal. The perforated bottom seal couples the separator to the container bottom side. Each of the perforated seals isolates the first compartment from the second compartment and while intact prevents mixing of contents stored therein.

The mixing mechanism (200) allows the separator (110) to rotate within the container body (101) to mix contents stored within the first compartment (120) with contents stored with the second compartment (130). The mixing mechanism comprises a center post rod (201) bisecting the separator into the first half (210) and the second half (211). The center post rod is rotatably coupled to the container bottom side (208). Coupled to the center post rod and extending above the hollow interior is a twist tab (206) to provide ergonomic turning of the separator. Upon rotation of the twist tab and subsequently the center post rod, the separator is configured to rotate and break from the plurality of perforated seals, thereby allowing the contents inside the first and second compartments to converge and mix. To encourage proper mixing, the separator comprises a contoured surface (205) at a top edge (212). The first half and the second half each comprise the contoured surface such that the first half and the second half are characterized as being in a mirror configuration with each other. Each contoured surface comprises a curvature that decreases toward the center post rod. Both the first compartment and the second compartment may comprise a lid to prevent spilling. After mixing is complete, a compartment access point (209) can be utilized to open the first compartment, the second compartment, or both to access the contents therein. In some embodiments, the dual compartment container may further comprise additional compartments (e.g. a third compartment, a fourth compartment, etc.) without deviating from the spirit of the embodiment. Generally, the separator is configured to rotate both clockwise and counterclockwise. In some embodiments, the mixing mechanism may further comprise a crossmember bar extending fully across the diameter of the hollow interior such that terminal ends of the crossmember bar contacts opposite sides of the interior periphery of the container body. The crossmember bar is fixedly coupled to the inner walls of the container body with the separator rotating independently below the crossmember bar. The crossmember bar improves the ability to rotate with resistance. The crossmember bar adds improved strength for hinge rotation and the separator support.

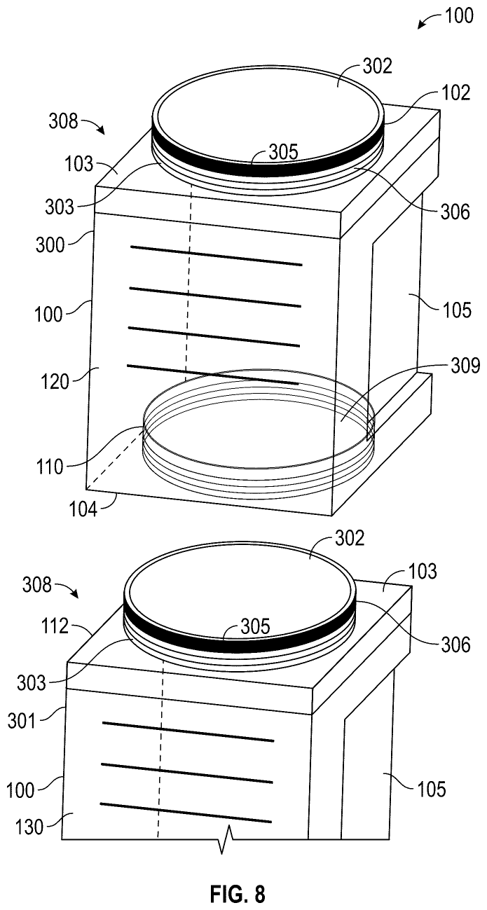

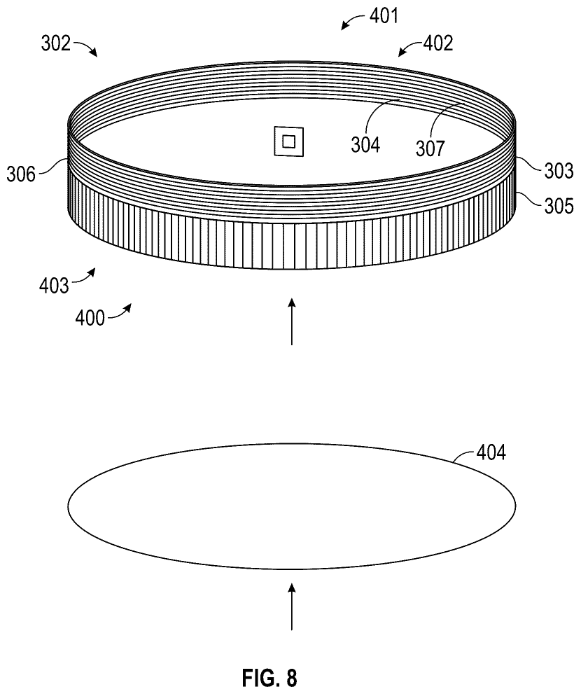

FIG. 8-9 show a dual compartment container (100) according to a fifth illustrated embodiment. The dual compartment container comprises a first compartment (120) and a second compartment (130) wherein the first compartment is associated with a first container (300) and the second compartment is associated with a second container (301). The first container is separate and distinct from the second container. The first container and the second container may comprise similar or identical features for attachments to additional containers. One having skill in the art will appreciate that features disclosed for the first container may also apply to the second container. The first container extends from a proximal end (103) to a distal end (104) and has a container body (101) with the first compartment surrounded by an exterior surface (105). Disposed at the proximal end is a proximal opening (112) for accessing contents within the first compartment. The proximal opening comprises opening threads (308) for engagement with a lid. The first container further comprises a threaded recess (309) disposed at the distal end.

A corresponding lid (302) is shown configured to engage with the proximal opening (112) at both the first container (300) and the second container (301). The lid comprises a lid outer periphery (303) and a lid inner periphery (304) opposite the lid outer periphery. The lid inner periphery comprises internal threads (307) configured to engage with the opening threads. The lid outer periphery comprises both gripping grooves (305) and external threads (306). The gripping grooves are provided to increase gripping capabilities for proper tightening and loosening. The external threads are configured to engage with the threaded recess of the second container. This allows for two containers to be stacked and coupled together for transportation and storage.

The gripping grooves (305) comprise threads having a thread direction orthogonal to the external threads (306). The gripping grooves are shown disposed near a top of the lid on the lid outer periphery (303) such that the gripping grooves are disposed above the external threads when the lid is coupled to the first container (300). This increases case of use when tightening or loosening. The external threads and the internal threads (307) are disposed on opposite sides of the lid periphery such that the external threads are directly external to the internal threads.

In some embodiments, the lid may further comprise a remote monitoring system (400) including a sensor (401). The remote monitoring system further comprises a battery (402) and wireless connectivity module (403) such as NFC or Bluetooth. The sensor is configured to measure one or more parameters including pressure, temperature, CO₂ levels, and the like. The sensor is disposed on an underside portion of the lid with a barrier seal covering the sensor from contents contained within the associated container.

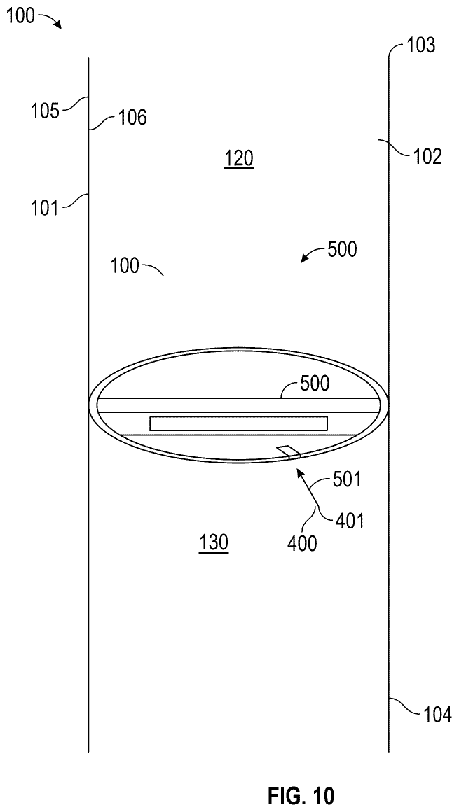

FIG. 10 shows a dual compartment container (100) according to a sixth illustrated embodiment. The dual compartment container comprises a container body (101) extending from a proximal end (103) to a distal end (104) with a separator (110) dividing a hollow interior (102) of the container body into a first compartment (120) and a second compartment (130). The separator extends radially toward inner walls (106) of the container body. The separator comprises ribs (500) and impressions for increased strength and rigidity between the first and second compartments. The ribs extend laterally along the separator towards opposite sides of the inner walls. The separator further comprises a cavity (501) for receiving a remote monitoring subsystem (400) including a sensor (401). The sensor is configured to slide within the cavity and is then hermetically sealed during the crimping process.

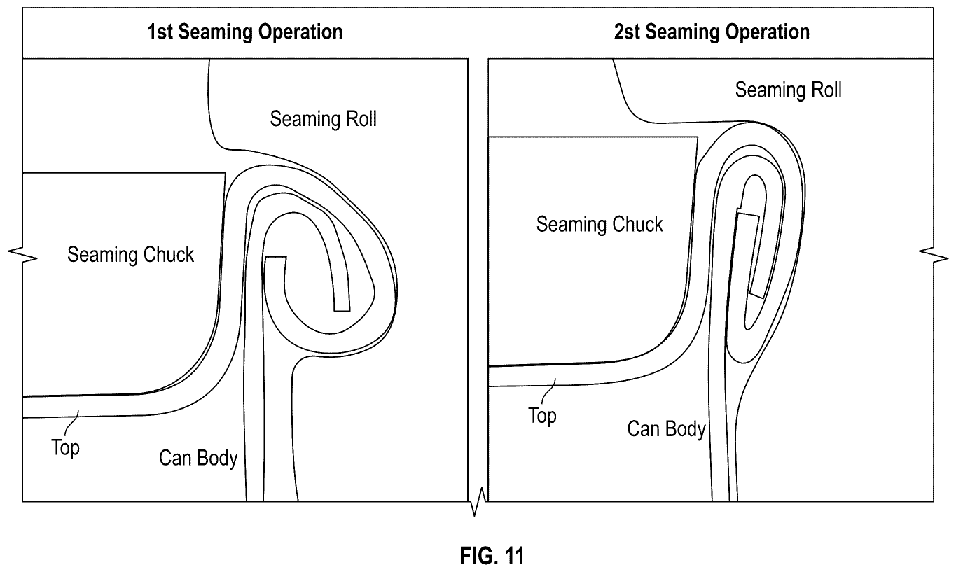

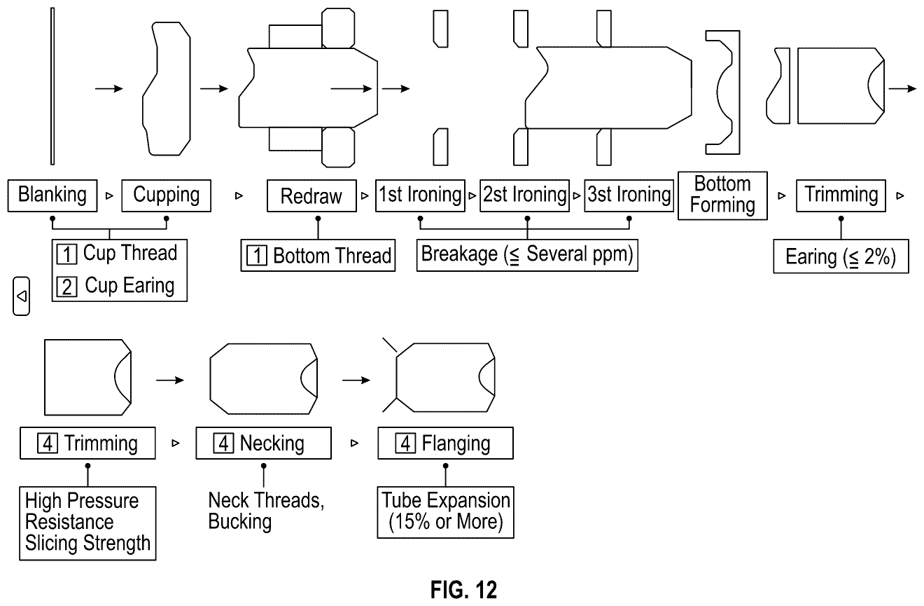

FIG. 11-12 show a diagram and flow chart for manufacturing metallic cans. Conventionally, a cylinder of the can is initially molded and stretched over repetitive incremental steps to create the bottom. The pre-assembled pop top lid edge is then folded in with the top cylindrical can edge. An adhesive combined with the double fold crimp creates the hermetic seal. In order to create the separator, the cylinder length can decrease as two separate cylinders are desired. The components comprise two cylinders, two preassembled pop top lids, and a seaming chuck. The first cylinder is conformed to the point where it has the open top and solid bottom, (standard process point). Its bottom would then be folded into the other cylinder in the same fold adhesive process used for the standard top connection. At that point, both cylinders would be separated internally but connected. With the fold marrying in the middle, it would keep the can strong enough to go through the filling of the container with contents, and for the crimp adhesive fold for the pop top at the top and bottom. To accomplish this, the edge of the first cylinder's closed bottom outer edge would be specially modified to accept the other cylinder but again the same fold process for the top would be the same method of connection. And as the can bottom has a dome shape the fold would go up inside that edge giving the can a finished side wall with a seam/crease connection circle around the cylinder. Inner linings may be applied to the bottom of the first cylinder outer bottom.

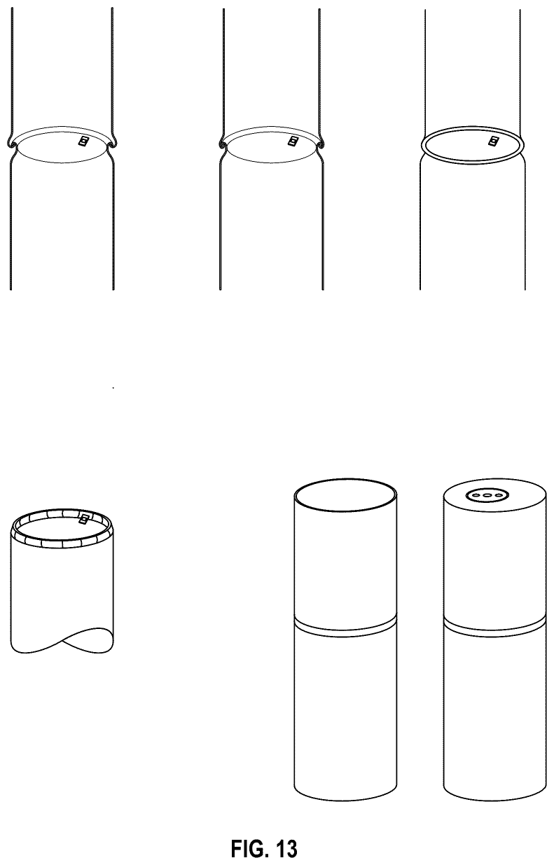

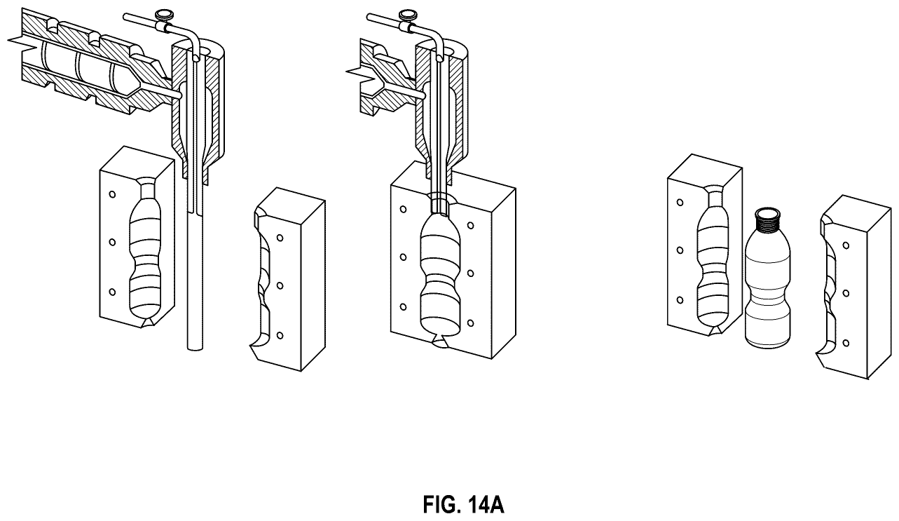

FIG. 13 shows a diagram for a method of manufacturing a metallic dual compartment can. Step 1: A slightly longer tapered cylinder is molded with a closed end, where the perimeter of the closed end features excess material around the cylinder wall at the junction with the end of the closed section. This preformed design provides sufficient excess material to facilitate the crimping, folding, and sealing processes during manufacturing. The cylinder is designed, engineered, and measured to ensure equal contents once the crimping and conjoining processes are completed. This step also includes the installation of a concealed micro sensor, wrapped in a protective coating, within the pre-molded hollow cavity. Step 2: The pre-molded closed side of compartment one is prepared for attachment to the cylinder. The open-ended cylinder of compartment two is engineered, designed, and measured such that, following the crimping and sealing processes, both compartments are equal in size. The initial folding process aligns the ends of the two compartments in an “S” shape, facilitating their interlocking. As the crimp folds in, this step also begins the hermetic sealing of both compartments and the pre-molded section for the micro sensor, which is encased within the outer wall perimeter and the compartment divider, ensuring it remains unobtrusive during the crimping process. (See FIG. 11). Step 3: The second phase of the crimp-fold process involves the melding, connecting, and fusing of the two separate compartments. Upon completion of this step, both compartments are hermetically sealed, and the micro sensor is positioned to sense conditions in either compartment, or both simultaneously. At this stage, the dual compartment container achieves sufficient rigidity and stability to proceed to the next manufacturing phase. Step 4: After the connection process, the first compartment of the dual compartment container is ready for filling and scaling. Following a precisely measured filling, the first pop top is installed through the crimping and sealing process (see Steps 2 and 3, and FIG. 11). Once the contents of the first compartment are filled and sealed, the sensor can immediately begin sensing that compartment. Step 5: The dual compartment container is rotated vertically and the second compartment undergoes the connection process, preparing it for filling. After a precisely measured filling and sealing, the second pop top is installed through the crimping process (see Steps 2 and 3, and FIG. 11). Once the contents of the second compartment are filled and sealed, the sensor can begin sensing that compartment independently, or it may sense both compartments simultaneously. Step 6: Both compartments have been hermetically sealed on all sides, with pop tops installed at both ends. The sensors are operational. The container is now ready for quality control, during which each container undergoes rigorous inspections to ensure that seals are intact, the filling process has not compromised the container's integrity, and that the sensors are functioning correctly.

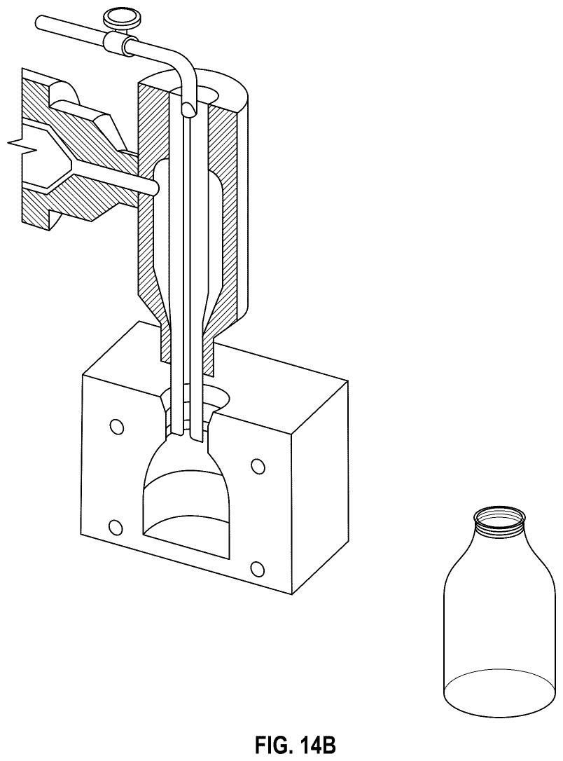

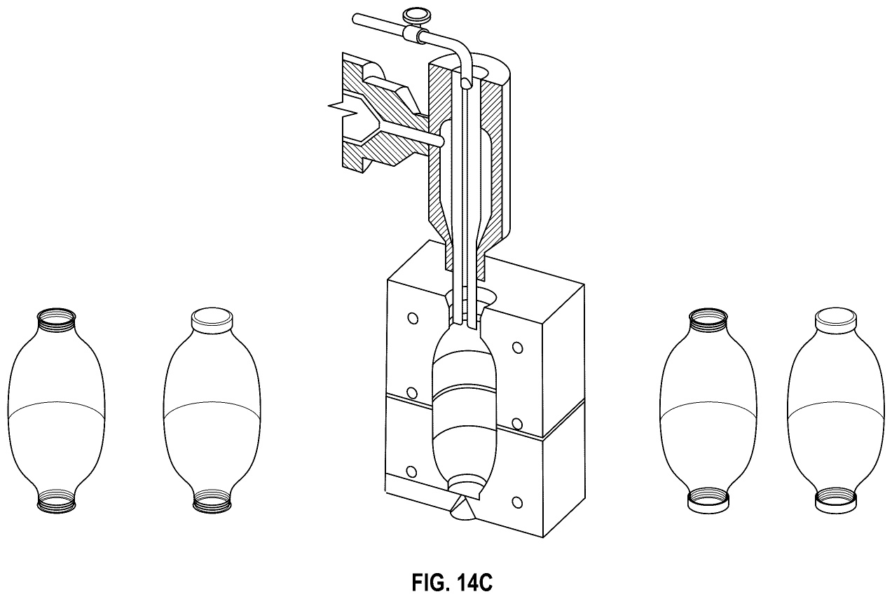

FIG. 14A-C show diagrams for a two-part method for manufacturing a dual compartment container. The two-part blow molding process for creating a dual compartment container involves several steps, utilizing specialized equipment and molds to produce a fused product with two identical compartments. The process begins with the extruder, where plastic resin is heated and melted. This molten plastic is then fed into a die head, which forms a parison—a hollow tube of plastic. The first mold comprises a cavity designed to create one compartment with a finished bottom and designed to accept a screw cap or any desired cap or lid. The parison is positioned inside the first mold. Air is introduced through an air hose to expand the parison against the walls of the mold cavity, forming the first compartment. Cooling lines in the mold help solidify the plastic as it takes shape. After the first compartment is formed and cooled, it is transferred to the second mold, which is designed to attach to the first compartment's bottom end, the end opposite the female or male screw cap, or any cap or lid opening. The second mold also has a cavity to create a second compartment of identical volume. The second mold designed to hold both compartments aligns the two compartments and is sealed. Blow pins from the second mold help ensure a proper fit and connect the two compartments together with the barrier from the first blow abutted to the other compartment's bottom end. The space between the compartments allows for the fusing of both compartments in the second blow. Air is again introduced via the air hose, causing the parison to expand and fill the second mold cavity. This forms the second compartment and fuses the two compartments, creating a seamless connection between the two compartments with a strong barrier in between. As with the first blow, cooling lines facilitate the solidification of the plastic, ensuring the integrity of the structure. Once both compartments are molded and cooled, the dual compartment container is fully formed. At this stage, it is ready for filling. The first compartment can now be filled with the desired product, followed by the installation of a lid to seal it. Next, the second compartment can now be rotated and filled with the desired product, followed by the installation of a lid to seal it. The fused dual compartment container is rotated for inspection to ensure quality standards are met. Finally, a heat shrink label wrap is applied around the container to enhance binding and add strength to the finished product. Components of the diagram are as follows: Air Hose: Supplies air for blowing the parison into the molds; Die Head: Extrudes the molten plastic to form the parison; Extruded Parison: The hollow tube of plastic that is blown into the mold; Cooling Lines: Circulate coolant to solidify the plastic during molding; Mold Cavity: The interior shape of the mold that determines the final form of each compartment; Blow Pins: Mechanisms that help secure and align the two mold sections during the fusing process; Finished Molded Dual Compartment Container: The final product consisting of two fused compartments ready for filling and labeling. The two-part blow method efficiently produces dual compartment containers that are strong and functional, with precise volume control and seamless integration between compartments. This process ensures high-quality manufacturing suitable for a wide range of products.

Other applications of the disclosed invention may include but are not limited to, aluminum cans (beer, soda, wine, etc.), pill containers, vitamin containers, juice containers, detergent/softener, water/flavored water, condiments (e.g. ketchup/mustard), peanut butter/jelly, salad dressings, milk/chocolate milk, various combinations of milk (e.g. almond milk, coconut milk, regular milk, nonfat milk), ice cream containers for two different ice creams or one of the same ice cream, seasoning container, tic tac, candies, cleaning supplies, automotive products, aeronautical products, sporting goods (e.g. screw top container bait products), paint/aerosol cans, cercal container, popcorn container, bullet/ammo container, or any other purpose as can be appreciated by one having skill in the art. The dual compartment container can be utilized for a pharmaceutical container design with compartments for active ingredients and stabilizers, featuring a barrier and mixing mechanism that activates upon user action, ensuring the preservation of ingredient integrity, efficacy, and security.

### FEATURE LIST

container (100)
container body (101)
hollow interior (102)
proximal end (103)
distal end (104)
exterior surface (105)
inner walls (106)
interior periphery (107)
separator (110)
separator periphery (111)
proximal opening (112)
distal opening (113)
first compartment (120)
first volume (121)
first substance (122)
second compartment (130)
second volume (131)
second substance (132)
pop top (140)
removable snap cover (141)
threaded cover (142)
mixing mechanism (200)
center post rod (201)
first perforated side seal (202)
second perforated side seal (203)
perforated bottom seal (204)
contoured surface (205)
twist tab (206)
container top side (207)
container bottom side (208)
compartment access point (209)
first half (210)
second half (211)
top edge (212)
first container (300)
second container (301)
lid (302)
lid outer periphery (303)
lid inner periphery (304)
gripping grooves (305)
external threads (306)
internal threads (307)
opening threads (308)
threaded recess (309)
remote monitoring subsystem (400)
sensor (401)
battery (402)
wireless connectivity module (403)
barrier seal (404)
reinforcement element (500)
cavity (501)

What is claimed is:

1. A dual compartment container, comprising:
a container body extending from a proximal end to a distal end opposite the proximal end, the container body further comprising a hollow interior surround by inner walls;
a separator disposed within the hollow interior, the separator coupled to the inner walls by a sealing mechanism;
a first compartment extending from the separator to the proximal end, the first compartment having a first volume and configured to store a first substance;
a second compartment extending from the separator the distal end, the second compartment having a second volume and configured to store a second substance;
a proximal opening disposed at the proximal end for accessing contents within the first compartment;
a distal opening disposed at the distal end for accessing contents within the second compartment;
wherein the first compartment and second compartment are independently accessible.

2. The dual compartment container of claim 1, wherein the separator extends radially from the hollow interior to the inner walls of the container body.

3. The dual compartment container of claim 1, the separator further comprising a planar formation and a separator periphery defining a perimeter of the planar formation, wherein the separator periphery comprises a same periphery as an interior periphery formed by the inner walls.

4. The dual compartment container of claim 1, wherein first volume equals the second volume.

5. The dual compartment container of claim 1, wherein the proximal opening and the distal opening each comprises a pop top.

6. The dual compartment container of claim 1, wherein the proximal opening and the distal opening each further comprises a removable snap cover configured to detachably couple to the respective opening.

7. The dual compartment container of claim 1, the first compartment further comprising the first substance stored therein, and the second compartment further comprising the second substance stored therein, wherein the first substance and the second substance are equivalent.

8. The dual compartment container of claim 1, further comprising a sensor configured to measure at least one of the first compartment and the second compartment.

9. The dual compartment container of claim 1, further comprising a reinforcement element coupled to separator for increased strength.

10. A dual compartment container, comprising:
a container body extending from a proximal end to a distal end opposite the proximal end, the proximal end forms a container top side and the distal end forms a container bottom side, the container body further comprises a hollow interior surrounded by inner walls;
a separator dividing the hollow interior into a first compartment and a second compartment, the separator comprising a first half and a second half;
a plurality of perforated seals coupled to both the separator and the inner walls for creating a barrier between the first compartment and the second compartment, wherein each of the plurality of perforated seals is configured to break upon rotation of the separator; and
a center post rod disposed between the first half and the second half of the separator, wherein the center post rod is rotatably coupled to the container bottom side.

11. The dual compartment container of claim 10, the plurality of perforated seals further comprising:
a first perforated side seal coupled to the first half of the separator and further coupled to a portion of the inner walls;
a second perforated side seal coupled to the second half of the separator and further coupled to a portion of the inner walls opposite the first perforated side; and
a perforated bottom seal coupled to the separator and further coupled to the container bottom side.

12. The dual compartment container of claim 10, further comprising a twist tab coupled to the center post rod.

13. The dual compartment container of claim 10, wherein the first half and the second half each comprise a contoured surface.

14. The dual compartment container of claim 13, wherein the first half and the second half are characterized as being in a mirror configuration.

15. The dual compartment container of claim 13, each of the contoured surfaces comprising a curvature wherein the curvature decreases toward the center post rod.

16. The dual compartment container of claim 10, wherein the separator is configured to rotate both clockwise and counterclockwise.

17. A dual compartment container, comprising:
a first container comprising a first container body extending from a first proximal end to a first distal end, the first container body forming a first compartment;
a first proximal opening disposed at the first proximal end, the first proximal opening comprising a first opening threads;
a first lid configured to engage with the first opening threads, the first lid further comprising a first lid outer periphery and a first lid inner periphery, the first lid inner periphery comprising a first internal threads configured to engage with the first opening threads, the first lid outer periphery comprising a first external threads;
a first threaded recess disposed at the first distal end of the first container body;
a second container comprising a second container body extending from a second proximal end to a second distal end, the second container body forming a second compartment;
a second proximal opening disposed at the second proximal end, the second proximal opening comprising a second opening threads;
a second lid configured to engage with the second opening threads, the second lid further comprising a second lid outer periphery and a second lid inner periphery, the second lid inner periphery comprising a second internal threads configured to engage with the second opening threads, the second lid outer periphery comprising a second external threads; and
a second threaded recess disposed at the second distal end of the second container body;
wherein the second external threads are configured to engage with the first threaded recess, and further wherein the first external threads are configured to engage with the second threaded recess.

18. The dual compartment container of claim 17, further comprising gripping grooves disposed on the first lid outer periphery.

19. The dual compartment container of claim 18, wherein the gripping grooves comprise a thread direction orthogonal to the first external threads.

20. The dual compartment container of claim 17, wherein the first external threads and the first internal threads are disposed on opposite sides of the first lid such that the external threads are directly opposite the first internal threads.
